(19) United States
(12) Patent Application Publication
(10) Pub. No.: US 2013/0079504 A1
(43) Pub. Date: Mar. 28, 2013

(54) POLYSACCHARIDE GEL AND PROCESS FOR PRODUCING SAME

(71) Applicant: JAPAN ATOMIC ENERGY AGENCY, Ibaraki (JP)

(72) Inventors: Atsushi KIMURA, Gunma (JP); Naotsugu NAGASAWA, Gunma (JP); Mitsumasa TAGUCHI, Gunma (JP)

(73) Assignee: JAPAN ATOMIC ENERGY AGENCY, Ibaraki (JP)

(21) Appl. No.: 13/626,097

(22) Filed: Sep. 25, 2012

(30) Foreign Application Priority Data
Sep. 26, 2011 (JP) 2011-209750

(51) Int. Cl. B01J 19/12; C08B 37/08; C08B 15/10

(52) U.S. Cl. 536/20; 536/56; 536/66; 204/157.63

(57) ABSTRACT

A mixture of a raw material poorly water-soluble polysaccharide or derivative thereof in an ionic liquid-containing solvent is exposed to radiation. Accordingly, a polysaccharide gel producing process is provided that can produce a gel without performing a special pretreatment for the raw material.

### TECHNICAL FIELD

The present invention relates to polysaccharide gels and processes for producing same that use poorly water-soluble polysaccharides as raw material.

### BACKGROUND ART

While petroleum synthetic polymers provide diversity and convenience in today's world, there are problems associated with these materials, including depletion of the raw material petroleum, emission of heat and carbon dioxide arising from the disposal of wastes, and contamination by environmentally-hazardous substances contained in the combustion gas and residues. Unlike the petroleum-based synthetic polymers, polysaccharides, a type of natural polymer, are digested and decomposed by composting, and represent an environmentally friendly resource material that can be recycled back to soil. Polysaccharides are thus expected to have use in a wide variety of fields, including food, drugs, cosmetics, medical appliances, liquid crystal displays, and separation membranes.

For example, cellulose, a typical polysaccharide, makes up about 40 to 70% of the cell membrane of higher plants, and represents the most abundant vegetable matter on earth. Cellulose has thus long been used as the main component of fiber materials such as paper, wood material, and cotton. The present applicant has proposed processes for producing gels having a cross-linked structure and usable for disposable diapers or other sanitary articles or as moisture retainers in the fields of medicine and cosmetics. The gels are produced by exposing a mixture of water and raw material alkylcellulose derivatives, chitin derivatives, and chitosan derivatives to radiation (see, for example, Patent Documents 1 (JP-A-2001-2703) and Patent Document 2 (JP-A-2003-160602).

### SUMMARY OF INVENTION

### Problems that the Invention is to Solve

However, cellulose, along with other polysaccharides such as chitin and chitosan extracted from the shells of crabs and shrimps are poorly water-soluble, and use of these materials directly as raw materials is restricted by the molding process. The raw materials thus require chemical treatments or some other pretreatment. In fact, such pretreatments are necessary in the processes previously proposed by the present applicant, and hydroxyl groups or carboxyl groups need to be introduced as functional groups to the raw material, because cellulose, chitin, and chitosan are insoluble in water, and cannot produce a desired gel by exposure to radiation.

The present invention has been made over these backgrounds, and it is an object of the present invention to provide a polysaccharide gel producing process that uses poorly water-soluble polysaccharides or derivatives thereof as raw material, and that can produce a gel without performing any special pretreatment for the raw material. The invention also provides a polysaccharide gel produced by the process.

### Means for Solving the Problems

In order to solve the foregoing problems, a polysaccharide gel producing process of the present invention includes exposing to radiation a mixture of a raw material poorly water-soluble polysaccharide or derivative thereof in an ionic liquid-containing solvent to obtain a gel.

It is preferable in the polysaccharide gel producing process that the radiation is given in a dose ranging from 0.1 to 500 kGy.

It is preferable in the polysaccharide gel producing process that the mixture contains the ionic liquid in a proportion of 200 to 10,000 weight parts with respect to 100 weight parts of the raw material.

It is preferable in the polysaccharide gel producing process that the solvent contains water, and that the content of the water in the mixture is 0.5 to 50 weight %.

It is preferable in the polysaccharide gel producing process that the raw material is at least one selected from cellulose, chitin, chitosan, and derivatives of these.

It is preferable in the polysaccharide gel producing process that the cations forming the ionic liquid are imidazolium cations, pyridinium cations, pyrrolidinium cations, piperidinium cations, phosphonium cations, or ammonium cations, and that the anions forming the ionic liquid are carboxylic acid anions, halogen anions, bis(trifluorosulfonyl)amide, tetrafluoroborate, or hexafluorophosphate.

A polysaccharide gel of the present invention is a polysaccharide gel obtained by using any of the foregoing processes, wherein the polysaccharide gel is formed of the poorly water-soluble polysaccharide or a derivative thereof with a cross-linked structure.

### Advantage of the Invention

The present invention can produce a polysaccharide gel from raw material poorly water-soluble polysaccharides or derivatives thereof without performing any special pretreatment for the raw material. The invention can also provide a polysaccharide gel formed of a poorly water-soluble polysaccharide or a derivative thereof with a cross-linked structure.

### MODE FOR CARRYING OUT THE INVENTION

In a polysaccharide gel producing process according to an embodiment of the present invention, a mixture of a raw material poorly water-soluble polysaccharide or a derivative thereof in an ionic liquid-containing solvent is exposed to radiation.

Natural polymers such as cellulose, chitin, and chitosan are insoluble in water by themselves, and are difficult to process by exposure to radiation. For this reason, these polymers have been subjected to a pretreatment, such as introducing hydroxyl groups or carboxyl groups to the polymer to provide solubility in water. With the polysaccharide gel producing process of the embodiment of the present invention, a polysaccharide gel can be obtained without performing such pretreatments for the raw material.

In the polysaccharide gel producing process of the present embodiment, for example, a powdery raw material is gradually added to an ionic liquid-containing solvent to obtain a mixture. The mixture is obtained as a low-concentration solution or a viscous high-concentration solution in a manner that depends on the concentration of the raw material. The form of the mixture includes a partially or entirely paste (starch) or slurry state. With the use of an ionic liquid-containing solvent in the present embodiment, the mixture can be obtained as a solution of the raw material, or as a uniform dispersion of the raw material.

In the present embodiment, the mixture obtained as above is exposed to radiation. Examples of the radiation include particle beams such as heavy ion beams, alpha rays, and beta rays, and ionizing radiation such as electron beams, X rays, and gamma rays. Electron beams and gamma rays commonly used in industry are more desirable, because large particle beams such as heavy ions have the risk of acting on the polysaccharide molecules in a non-uniform fashion.

The mixture may be exposed to the radiations in any dose sufficient to cross-link the polysaccharide and a derivative thereof. The radiation dose ranges preferably from 0.1 to 500 kGy, more preferably 1 to 100 kGy, particularly preferably 5 to 60 kGy. By exposing the mixture to 0.1 to 500 kGy radiation, the polysaccharide and a derivative thereof in the mixture can be cross-linked more effectively to obtain a polysaccharide gel.

The temperature for radiation exposure may be set within a range of typically from 25 to 100° C., though it depends on the type of the ionic liquid used. For example, in the case of an ionic liquid using a halide as an anion, the temperature for radiation exposure is set to 70° C. or higher, at or above the melting point. For an ionic liquid in which an organic acid ion such as a carboxylic acid anion is used as an anion, a temperature of 25° C. or more, at or above the melting point, is considered for radiation exposure.

The mixture ratio of the raw material polysaccharide or derivative thereof to the ionic liquid in preparing the mixture may be such that, for example, the proportion of the ionic liquid is 200 to 10,000 weight parts with respect to 100 weight parts of the raw material. In this range of mixture ratio, the raw material can be effectively dissolved. Considering factors such as the solubility of the raw material and the cost of the ionic liquid, it is desirable that the ionic liquid is 200 to 1,000 weight parts, more desirably 300 to 800 weight parts with respect to 100 weight parts of the raw material.

For preparing the mixture, water may be added to the raw material as a solvent other than the ionic liquid. Water may be, for example, city water, industrial water, deaerated water, deionized water, gel filtrated water, or distilled water. Those containing no oxygen or ions are preferred.

When added to the raw material, for example, water may be added in a proportion of 10 to 10,000 weight parts with respect to 100 weight parts of the raw material. Considering the solubility of the raw material, water should preferably be added to make the water content in the mixture 0.5 to 50 weight %, preferably 0.5 to 30 weight %, particularly preferably 0.5 to 20 weight %.

In the polysaccharide gel producing process of the present embodiment, specific examples of the raw material poorly water-soluble polysaccharides include cellulose, chitin, chitosan, alginic acid (excluding metal salt forms such as sodium), dextran, hyaluronan (excluding metal salt forms such as sodium), and β glucan.

In the polysaccharide gel producing process of the present embodiment, the raw material derivatives of poorly water-soluble polysaccharides are derivatives of the polysaccharides above. The polysaccharide derivatives may be those produced by chemically modifying the polysaccharides, or may be commercially available products. Specific examples of cellulose derivatives as examples of the polysaccharide derivatives include cellulose acetate, ethylcellulose, hydroxypropyl methylcellulose phthalate, cellulose acetate hexahydrophthalate, hydroxypropyl methylcellulose acetate phthalate, hydroxypropyl methylcellulose hexahydrophthalate, and hydroxypropyl methylcellulose tetrahydrophthalate. Specific examples of chitin derivatives include acetylchitin, and benzylchitin. Specific examples of chitosan derivatives include haloacylchitosan, benzylchitosan, and benzoylchitosan.

The polysaccharides and derivatives thereof may be used as raw materials either alone or in a combination of two or more.

In the polysaccharide gel producing process of the present embodiment, examples of the cations forming the ionic liquid include imidazolium cations, pyridinium cations, pyrrolidinium cations, piperidinium cations, phosphonium cations, and ammonium cations. Examples of the anions forming the ionic liquid include organic acid ions (including carboxylic acid anions such as formic acid anions and acetic acid anions), halogen anions (such as chlorine anions, bromine anions, and iodine anions), bis(trifluorosulfonyl)amide, tetrafluoroborate, and hexafluorophosphate.

Specific examples of the ionic liquid include 1-ethyl-3-methylimidazolium chloride, 1-ethyl-3-methylimidazolium bromide, 1-ethyl-3-methylimidazolium bis(trifluorosulfonyl)amide, 1-ethyl-3-methylimidazolium formate, 1-ethyl-3-methylimidazolium acetate, 1-butyl-3-methylimidazolium chloride, 1-butyl-3-methylimidazolium bromide, 1-butyl-3-methylimidazolium tetrafluoroborate, 1-butyl-3-methylimidazolium bis(trifluorosulfonyl)amide, 1-butyl-3-methylimidazolium thiocyanate, 3-methyl-octylimidazolium chloride, 3-methyl-hexadecylimidazolium chloride, N-ethylpyridinium chloride, N-ethylpyridinium bromide, N-butylpyridinium chloride, N-butylpyridinium bromide, N-octylpyridinium chloride, 4-methyl-N-butylpyridinium chloride, 4-methyl-N-butylpyridinium bromide, N-methyl-N-propylpyrrolidinium bis(trifluorosulfonyl)amide, 1,1-dimethylpyrrolidinium iodide, 1-butyl-1-methylpyrrolidinium chloride, 1-hexyl-1-methylpyrrolidinium chloride, 1-methyl-1-octylpyrrolidinium chloride, N-butyl-N-methylpyrrolidinium bis(trifluorosulfonyl)amide, N-methyl-N-propylpiperidinium bis(trifluorosulfonyl)amide, trihexyl(tetradecyl)phosphonium chloride, trihexyl(tetradecyl)phosphonium tetrafluoroborate, N,N-diethylmethyl-(2-methoxyethyl)ammonium bis(trifluorosulfonyl)amide, N,N-diethylmethyl-(2-methoxyethyl)ammonium tetrafluoroborate, N,N-diethylmethyl-(2-methoxyethyl)ammonium hexafluorophosphate, N,N-diethylmethyl-(2-methoxyethyl)ammonium chloride, N,N-diethylmethyl-(2-methoxyethyl)ammonium bromide, N,N-diethylmethyl-(2-methoxyethyl)ammonium formate, and N,N-diethylmethyl-(2-methoxyethyl)ammonium acetate. These ionic liquids may be used either alone or as a mixture of two or more.

With the producing process of the present embodiment described above, a polysaccharide gel can be obtained that is formed of a poorly water-soluble polysaccharide or a derivative thereof with a cross-linked structure. Because polysaccharides such as cellulose, chitin, and chitosan are plant- or animal-derived natural polymers, the polysaccharide gel using these raw materials are environmentally friendly materials.

The polysaccharide gel can absorb water, or organic solvents such as methanol, ethanol, acetone, dichloromethane, and dimethylacetoamide, and can thus be used as an absorber or a moisture retainer for disposable diapers or other sanitary articles in the fields of medicine and cosmetics. For example, a polysaccharide gel can be obtained that can absorb water or an organic solvent in amounts equal to or greater than the weight of the polysaccharide gel itself.

The present invention is described below in more detail using examples. It should be noted that the descriptions of the following examples are not intended to limit the present invention in any ways.

### EXAMPLES

### Example 1

1-Ethyl-3-methylimidazolium acetate (310 weight parts) and water (90 weight parts) were added to cellulose (MERCK; 100 weight parts) to obtain a 20 weight % cellulose solution at 25° C. The water content in the solution was 18 weight %. The solution was exposed to γ rays in 5 to 60 kGy at 25° C.

The cellulose cross-linking reaction occurred at 5 kGy, and the gel fraction reached the maximum value 10% at 10 kGy.

The absorption of 5% lithium chloride.dimethylacetoamide in the gel was 10 weight parts per weight part of the dry gel.

Formation of a gel after exposure to γ rays was not confirmed in a sample mixture that contained cellulose and water but no ionic liquid.

Here and below, the gel fraction was determined as follows.

The sample was dried after being exposed to radiation, and further dried in a 50° C. vacuum drier until the sample had a constant mass. The dried sample was placed in a 200-mesh stainless-steel mesh, and dipped in large amounts of distilled water at room temperature for 24 hours. Here, the non-cross-linked dissolved portion moves to the distilled water, and only the gel component remains in the stainless-steel mesh. The stainless-steel mesh with the gel component was thoroughly washed with distilled water, dipped in methanol for 1 hour, and dried at 50° C. for 24 hours. The gel fraction was calculated according to the following equation.

Gel fraction (%)=(gel dry weight excluding the dissolved component/initial dry weight)×100

Here and below, the absorption of the 5% lithium chloride•dimethylacetoamide was determined as follows.

The sample after the exposure to radiation was dipped in large amounts of a 5% lithium chloride.dimethylacetoamide solution at room temperature for 24 hours. After washing the sample with large amounts of distilled water, the residual gel was freeze dried to obtain a dry gel.

The absorption of dimethylacetoamide was represented by the amount of the 5% lithium chloride•dimethylacetoamide absorbed by 1 g of the dry gel dipped in large amounts of 5% lithium chloride.dimethylacetoamide (equilibrated weight in 25° C. dimethylacetoamide).

### Example 2

1-Butyl-3-methylimidazolium bromide (730 weight parts) and water (170 weight parts) were added to chitin (Funakoshi Corporation; 100 weight parts) to obtain a 10 weight % chitin slurry mixture at 25° C. The water content in the mixture was 17 weight %. The mixture was exposed to γ rays in 10 kGy at 25° C. The sample after the exposure had a gel fraction of 46%, confirming gel formation.

The absorption of the 5% lithium chloride•dimethylacetoamide in the gel was 10 weight parts per weight part of the dry gel.

The absorption of the water in the gel was 7.5 weight parts per weight part of the dry gel. The absorption of water was represented by the amount of water absorbed by 1 g of the dry gel dipped in large amounts of water after the dry gel was obtained by using the same method used to obtain the dry gel for the measurement of the absorption of 5% lithium chloride.dimethylacetoamide (equilibrated weight in 25° C. water).

Formation of a gel after exposure to γ rays was not confirmed in a sample mixture that contained chitin and water but no ionic liquid.

### Example 3

N,N-Diethylmethyl-(2-methoxyethyl)ammonium formate and N,N-diethylmethyl-(2-methoxyethyl)ammonium bis(trifluorosulfonyl)amide (200 weight parts each) were added to hydroxypropyl methylcellulose phthalate (Shin-Etsu Chemical Co., Ltd.; 100 weight parts) to obtain a 20 weight % cellulose solution at 25° C. The solution was exposed to γ rays in 20 kGy at 25° C.

The sample after the exposure was measured for dynamic viscoelasticity. The sample had an almost constant elastic modulus in a 1 to 100 rad/s measurement frequency range, showing the behavior of a gel material. This confirmed the formation of a gel. It was also confirmed that the sample after the exposure to radiation absorbed acetone.

Formation of a gel after exposure to γ rays was not confirmed in a sample mixture that contained hydroxypropyl methylcellulose phthalate and water but no ionic liquid.

1. A polysaccharide gel producing process comprising exposing to radiation a mixture of a raw material poorly water-soluble polysaccharide or derivative thereof in an ionic liquid-containing solvent to obtain a gel.

2. The process according to claim 1, wherein the radiation is given in a dose ranging from 0.1 to 500 kGy.

3. The process according to claim 1, wherein the mixture contains the ionic liquid in a proportion of 200 to 10,000 weight parts with respect to 100 weight parts of the raw material.

4. The process according to claim 1, wherein the solvent contains water, and wherein the content of the water in the mixture is 0.5 to 50 weight %.

5. The process according to claim 1, wherein the raw material is at least one selected from cellulose, chitin, chitosan, and derivatives of these.

6. The process according to claim 1, wherein the cations forming the ionic liquid are imidazolium cations, pyridinium cations, pyrrolidinium cations, piperidinium cations, phosphonium cations, or ammonium cations, and wherein the anions forming the ionic liquid are carboxylic acid anions, halogen anions, bis(trifluorosulfonyl)amide, tetrafluoroborate, or hexafluorophosphate.

7. A polysaccharide gel obtained by using the process of claim 1, wherein the polysaccharide gel is formed of the poorly water-soluble polysaccharide or a derivative thereof with a cross-linked structure.

8. The process according to claim 2, wherein the mixture contains the ionic liquid in a proportion of 200 to 10,000 weight parts with respect to 100 weight parts of the raw material.

9. A polysaccharide gel obtained by using the process of claim 2, wherein the polysaccharide gel is formed of the poorly water-soluble polysaccharide or a derivative thereof with a cross-linked structure.

10. A polysaccharide gel obtained by using the process of claim 3, wherein the polysaccharide gel is formed of the poorly water-soluble polysaccharide or a derivative thereof with a cross-linked structure.

11. A polysaccharide gel obtained by using the process of claim 8, wherein the polysaccharide gel is formed of the poorly water-soluble polysaccharide or a derivative thereof with a cross-linked structure.

12. A polysaccharide gel obtained by using the process of claim 4, wherein the polysaccharide gel is formed of the poorly water-soluble polysaccharide or a derivative thereof with a cross-linked structure.

13. A polysaccharide gel obtained by using the process of claim 5, wherein the polysaccharide gel is formed of the poorly water-soluble polysaccharide or a derivative thereof with a cross-linked structure.

14. A polysaccharide gel obtained by using the process of claim 6, wherein the polysaccharide gel is formed of the poorly water-soluble polysaccharide or a derivative thereof with a cross-linked structure.
